(19) United States
(12) Patent Application Publication
(10) Pub. No.: US 2026/0117493 A1
(43) Pub. Date: Apr. 30, 2026

(54) PIN AND BUSHING WEAR DETECTION SYSTEM AND METHOD OF A WORK VEHICLE WITH A LINKAGE ASSEMBLY AND WORK TOOL

(71) Applicant: Deere & Company, Moline, IL (US)

(72) Inventors: Daniel M. Kassen, Hazel Green, WI (US); Matthew M. Less, Dubuque, IA (US)

(21) Appl. No.: 19/299,396

(22) Filed: Aug. 14, 2025

Related U.S. Application Data
(60) Provisional application No. 63/714,399, filed on Oct. 31, 2024.

(51) Int. Cl. E02F 9/26; E02F 9/22; G01M 17/007

(52) U.S. Cl. CPC E02F 9/267; G01M 17/007; E02F 9/221

(57) ABSTRACT

A work vehicle comprising a main frame, a first sensor coupled with the work tool, a work tool movably coupled with the main frame, a second sensor coupled with the main frame, and a controller. The controller is in communication with the first sensor and the second sensor, wherein the controller includes a processor and a memory having a work tool shake measurement sequence algorithm stored thereon, wherein the processor is operable to execute the work tool shake measurement sequence algorithm to determines if the movement amount of the first sensor exceeds an excessive wear threshold.

### RELATED APPLICATION

This document (including the drawings) claims priority and the benefit of the filing date based on U.S. provisional application No. 63/714,399 filed Oct. 31, 2024, and titled WORK VEHICLE WITH A PIN AND BUSHING WEAR DETECTION ON A WORK VEHICLE LINKAGE ASSEMBLY WITH WORK TOOL AND METHOD under 35 U.S.C. § 119(e), where the provisional application is hereby incorporated by reference herein.

### TECHNICAL FIELD

The present disclosure relates generally to detecting wear in moving parts. More specifically, the present disclosure relates to detecting wear in parts on a work vehicle linkage assembly coupling a work tool.

### BACKGROUND

Pins and bushings where the work tool couples to the main frame need replacement during the lifespan of a work vehicle. However, the frequency of replacement and maintenance vary depending on a multiple of factors. These factors include the type of machine, the operating conditions, the quality of maintenance, and the intensity of use. As a general guideline, pins and bushings in work vehicles such as loaders, excavators, crawlers, and dozers may need to be replaced at regular intervals, typically ranging from every 1000 to 5000 hours of operation. Manual inspections used to identify wear, damage, or excessive clearance are time consuming by requiring disassembly of components and are subject to the experience of the operator. Furthermore, with the advancement of precision control in work vehicles, maintenance of moving parts is critical in achieving optimal results. With the wide-ranging maintenance window, the timing and frequency of maintaining pins and bushings can be subjective. Therein lies an opportunity for an improved process for indicating pin and bushing wear that can be assessed objectively while done efficiently and with ease, and potentially even remotely.

### SUMMARY

According to an aspect of the present disclosure, a work vehicle comprises of a main frame, a work tool movably coupled with the main frame, one or more sensors coupled with at least the work tool, and a controller. The controller is in communication with a first sensor and possibly second sensor, wherein the controller includes a processor and a memory having a work tool shake measurement sequence algorithm stored thereon, wherein the processor is operable to execute the work tool shake measurement sequence algorithm to perform the following. In a first step, the processor positions the work tool above the ground surface and activates the work tool shake measurement sequence. Next, the processor monitors the second sensor to determine a movement amount for the second sensor relative to the first sensor. Finally, the processor determines if the movement amount of the second sensor exceeds an excessive wear threshold. Alternatively, the processor monitors the first sensor to determine a movement amount and direction of the work tool as compared to a known baseline.

In one particular embodiment, the work tool comprises of a dozer blade.

The work tool shake measurement sequence comprises of shaking the work tool by repeatedly expanding and contracting a work tool actuator coupled with the work tool. Expansion and contraction of the work tool actuator is performed at less than maximum amount of hydraulic flow capacity capable of going to the work tool actuator. The expansion and contraction of the work tool actuator is performed at 50% of a hydraulic flow capacity going to the work tool actuator.

The work vehicle may further comprise of a display.

The work tool shake measurement sequence algorithm further comprises displaying an alert on the display when the movement amount of the first sensor exceeds the excessive wear threshold.

The work tool shake measurement sequence activate step comprises increasing expansion and contraction of the work tool actuator coupled with the work tool until a threshold velocity of the first sensor is reached. The expanding and contracting of the work tool actuator is performed at 40% and above 20% of a maximum amount of hydraulic flow capacity of going to the work tool actuator. The wear threshold may be monitored in a direction of roll.

According to another aspect of the present disclosure, a method for evaluating bushings comprises positioning a work tool above a ground surface, activating a work tool shake measurement sequence, monitoring by the controller a first inertial measurement unit (sensor) coupled with the work tool with respect to a second sensor coupled with the main frame to determine a movement amount for the first sensor, and finally determining by the controller if the movement amount of the first sensor exceeds an excessive wear threshold.

The controller is in communication with the first sensor and the second sensor, where the controller includes a processor and a memory having a work tool shake measurement sequence algorithm stored thereon. The work tool shake measurement sequence comprises shaking the work tool by repeatedly expanding and contracting a work tool actuator coupled with the work tool.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 illustrates a side view work vehicle shown as a crawler.

FIG. 2A is a rear perspective view of the linkage assembly of the work vehicle in

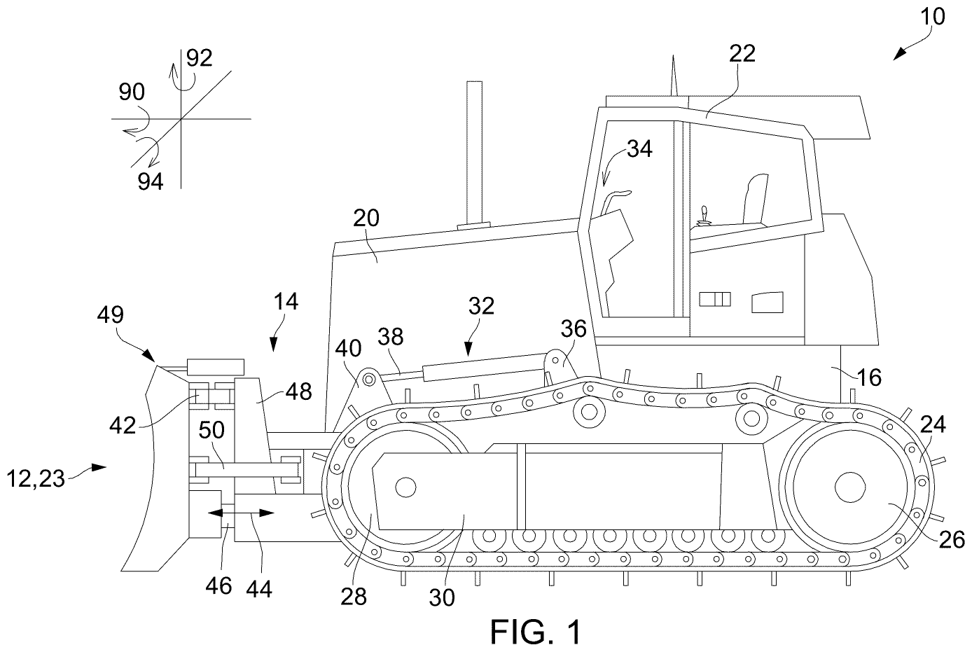

FIG. 1.

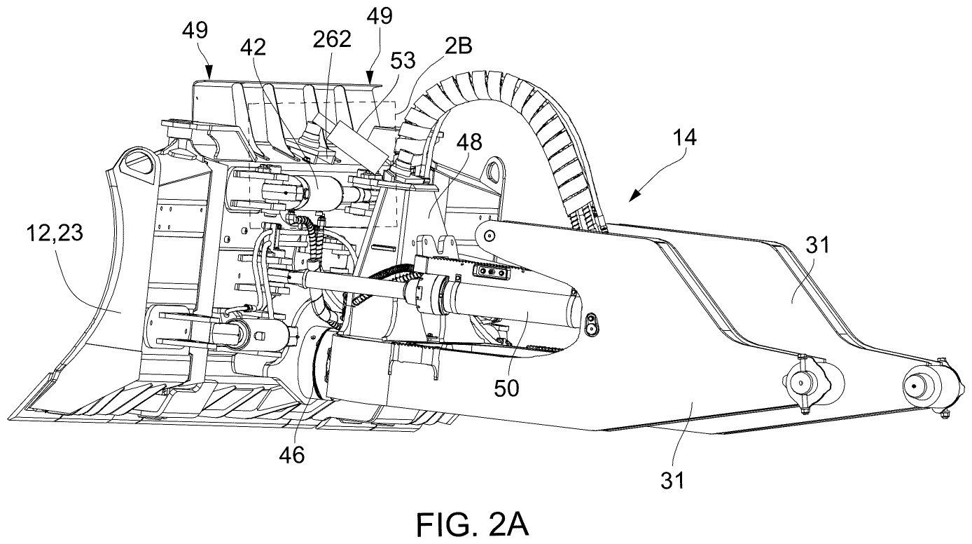

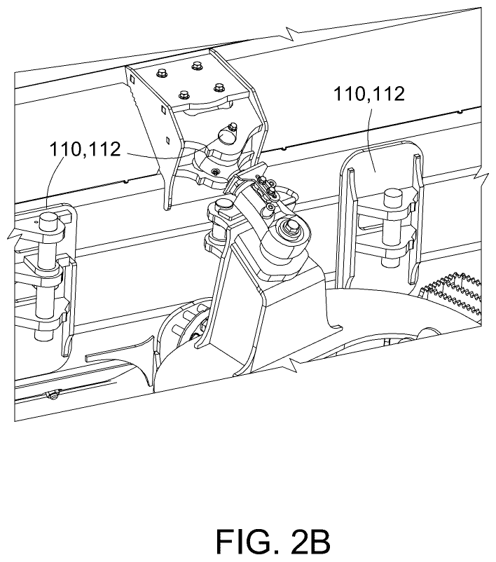

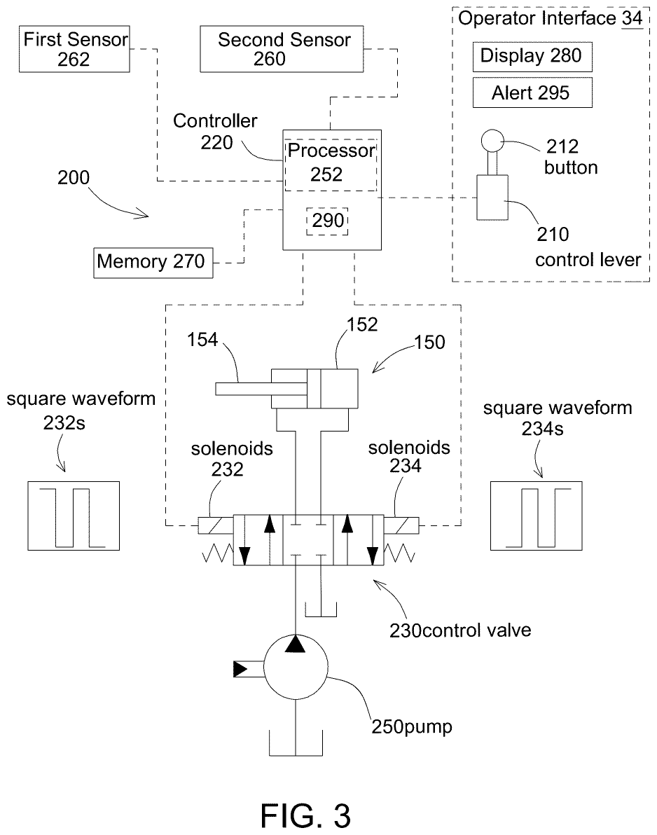

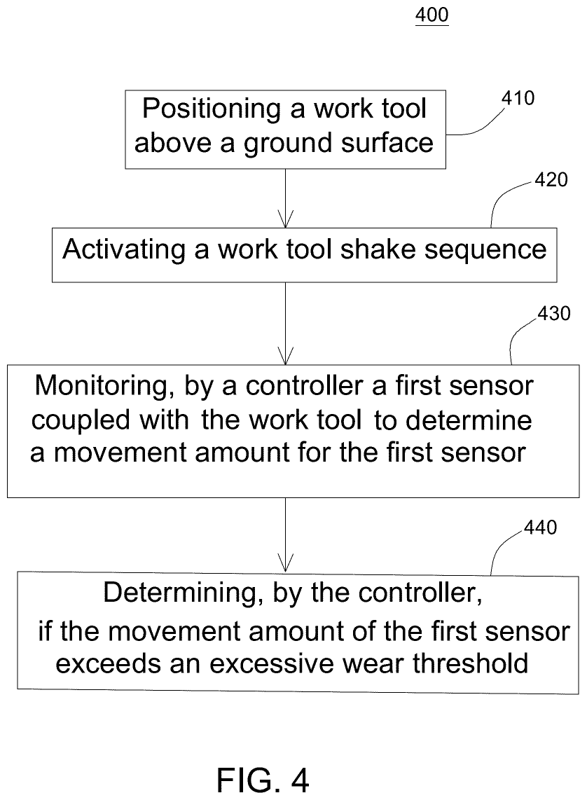

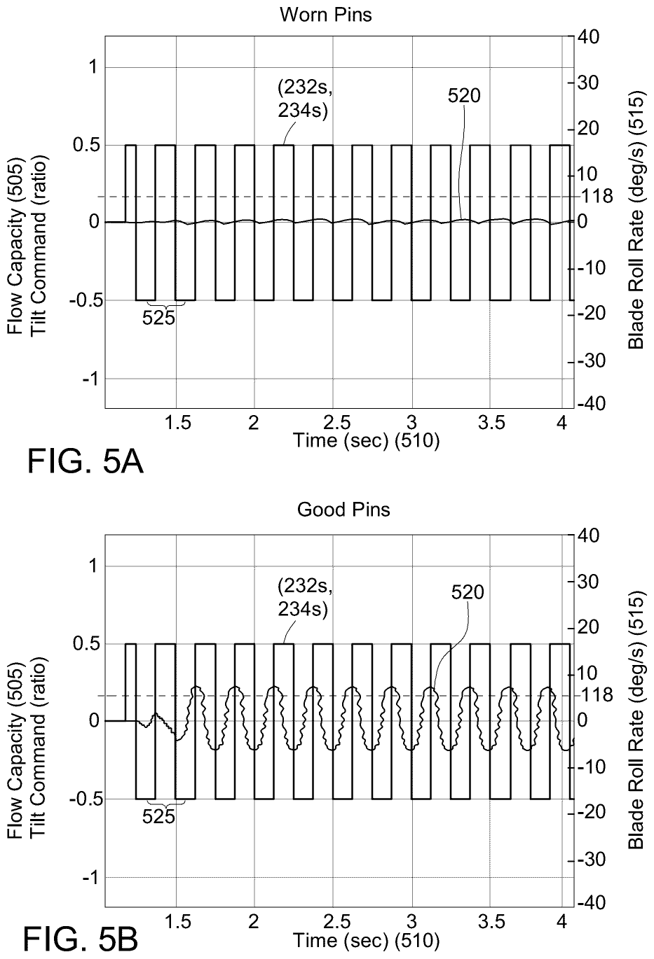

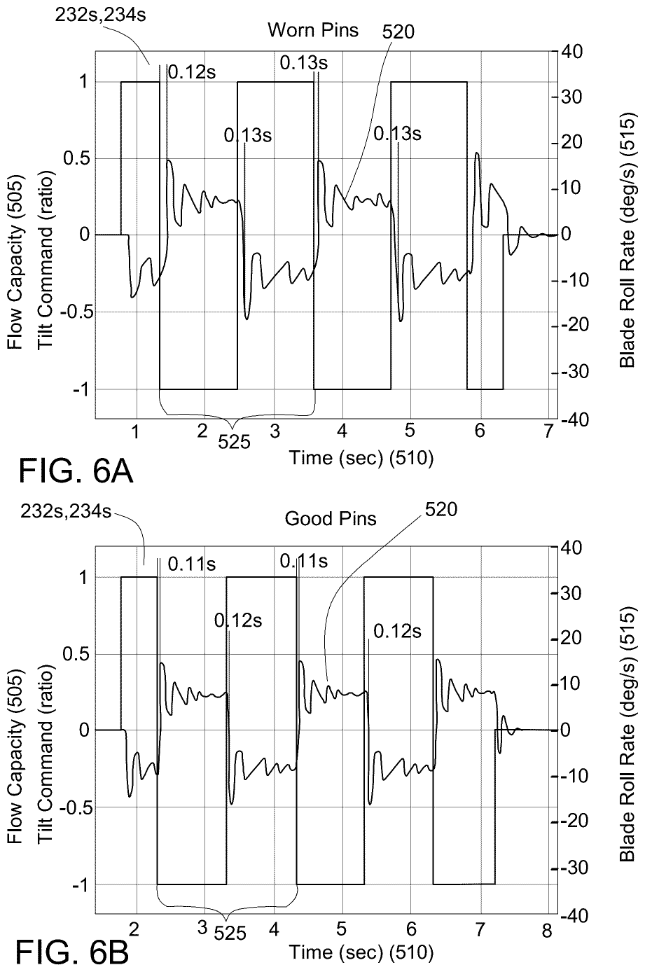

FIG. 2B is a detailed view of the backside of the linkage assembly shown in FIG. 2A.

FIG. 3 illustrates a schematic of an exemplary embodiment of a pin and bushing wear detection system.

FIG. 4 is a diagram showing steps for a method of detecting wear on bushings on a work vehicle, consistent with embodiments of the present disclosure.

FIG. 5A illustrates an overlay of motion signals over extension/retraction signals with good pins/bushings at a threshold frequency.

FIG. 5B illustrates an overlay of motion signals over extension/retraction signals with worn pins/bushings at a threshold frequency.

FIG. 6A illustrates an overlay of motion signals over extension/retraction signals with good pins/bushings above a threshold frequency.

FIG. 6B illustrates an overlay of motion signals over extension/retraction signals with worn pins/bushings above a threshold frequency

Like reference numerals are used to indicate like elements throughout the several figures.

### DETAILED DESCRIPTION

Reference will now be made to the embodiments described herein and illustrated in the drawings and specific language will be used to describe the same. It will nevertheless be understood that no limitation of the scope of the novel invention is thereby intended. Such alterations and further modifications in the illustrated devices and method, and such further applications of the principles of the novel invention as illustrated therein being contemplated as would normally occur to one skilled in the art to which the novel invention relates.

FIG. 1 illustrates a side view of a work vehicle 10, shown as a crawler dozer, including a work tool 12 such as a dozer blade 23, which is coupled to the main frame 16 by a linkage assembly 14 (shown in FIGS. 1, 2A and 2B). Other work tools, including moldboards, are contemplated. The work vehicle 10 includes the main frame 16 which houses a power source (not shown) located within the housing 20. The work vehicle 10 includes a cab 22 where an operator sits to operate the vehicle. The vehicle is driven by a belted track 24 which operatively engages a rear main drive wheel 26 and a front auxiliary drive wheel 28. The belted track is tensioned by a tension and recoil assembly 30. The belted track is provided with centering guide lugs for guiding the track across the drive wheels (26, 28), and grouser for frictionally engaging the ground.

While the described embodiments are discussed with reference to a crawler dozer, other work vehicles are contemplated including other types of construction vehicles, forestry vehicles, as well as on-road vehicles such as those used to plow snow. Actuators used in these work vehicles include in one or more of tilt, angle, pitch, lift, arm, boom, bucket, blade side shift, blade tilt, and actuators.

The main drive wheels 26 are operatively coupled to a steering system which is in turn coupled to a power source. The power source and other systems (such as hydraulics) powered by the power source may be actuated in response to operator input from an operator interface 34.

The dozer blade 23 (the work tool 12) is raised and lowered by the linkage assembly 14 which includes a number of actuators, such as hydraulic cylinders, to adjust the position of the dozer blade 23. The linkage assembly 14 includes a C-frame 31 that is raised and lowered with respect to the main frame 16 by a lift actuator 32. A second lift actuator (not shown) is located on another side of the housing 20. Each of the lift actuators 32 comprise of a hydraulic actuator with a body, or cylinder, rotatably coupled to the main frame 16 at a standoff 36, and an arm 38 that extends and retracts from the cylinder. Arm 38 is rotatably coupled to a plate 40 that extends from the C-frame 31 to raise and lower the C-frame 31 and therefore the dozer blade 23. Other configurations or raising and lowering the dozer blade 23 are contemplated including vertically oriented actuators. The movement for work tool 12 may be referred to as roll 90 or the roll direction, pitch 94 or the pitch direction, and yaw 92 or the yaw direction.

The dozer blade 23 is tilted relative to work vehicle 10 by the actuation of a tilt actuator 42 wherein the dozer blade 23 is rotatable about an axis 44 of a spherical bearing 46. For the tilt actuator 42, a rod end is pivotally connected to a clevis positioned on the back and left sides of dozer blade 23 above the spherical bearing 46. A head end of the tilt actuator 42 is pivotally connected to an upward projecting portion 48 that extends from the C-frame 31. The opposite end of the tilt actuator 42 is coupled to a backside of the dozer blade 23. The positioning of the pivotal connections for the head end and the rod end of tilt actuator 42 result in tilting dozer blade 23 to the left (counterclockwise) or right (clockwise) when viewed from cab 22. Extension of rod of the tilt actuator 42 tilts the dozer blade counterclockwise. Retraction of tilt actuator 42 tilts dozer blade 23 to the right or clockwise when viewed from operator's cab 22. In alternative embodiments, dozer blade 23 is tilted by different mechanisms (e.g., an electrical or hydraulic motor). Tilt actuator 42, in one or more embodiments, is configured differently, such as a configuration in which tilt actuator 42 is mounted vertically and positioned on the left or right side of dozer blade 23, or a configuration with two tilt actuators 42.

Dozer blade 23 is angled relative to work vehicle 10 by the actuation of angle actuators 50, one of which is illustrated. For each of angle actuators 50, the rod end is pivotally connected to dozer blade 23 while the head end is pivotally connected to C-frame 31. One of angle actuators 50 is positioned on the left side of the work vehicle 10, and the other angle actuators are positioned on the right side of work vehicle 10. An extension of the left angle actuator 50 and the retraction of the right-angle actuator 50 angles the dozer blade rightward such that the right side of the dozer blade 23, as viewed from the cab 22, is pulled closer to the cab 22. Retraction of the left angle actuator 50 and the extension of the right-angle actuators 50 angles dozer blade 23 leftward, such that the left side of the dozer blade 23 is pulled closer to the cab 22.

The dozer blade 23 is pitched with respect to the cab 22 with a pitch actuator 53 connected to the upward projection portion 48, at one end, and connected to the dozer blade 23 at another end. Extension and retraction of the pitch actuator 53 moves a top portion 49 of the dozer blade 23 toward or away from the cab 22 to achieve a desired pitch. Pitch of the dozer blade 23 is also provided by raising and lowering the C-frame 31 with the lift actuators 32 having ends coupled to pivot locations 55. In another embodiment, the pitch actuator 53 is not included and retraction and extension of the lift actuators 32 pitches the dozer blade 23 about the spherical bearing 46.

As seen in FIG. 3, a controller 220 includes a processor 252 and a memory 270. In other embodiments, the controller 220 may be a distributed controller having separate individual controllers distributed at different locations on the work vehicle 10. In addition, the controller 220 is generally hardwired by electrical wiring or cabling to related components. In other embodiments, however, the controller 220 includes a wireless transmitter and/or receiver to communicate with a controlled or sensing component or device which provides information to the controller 220 or transmits controller information to controlled devices.

The controller 220 executes or otherwise relies upon software applications, components, programs, objects, modules, or data structures, etc. Software routines and program instructions reside in the included memory 270 of the controller 220, or other memory, and are executed in response to the signals received. The computer software applications, in other embodiments, are located in the cloud. The executed software includes one or more specific applications, components, programs, objects, modules or sequences of instructions typically referred to as “program code”. The program code includes one or more instructions located in memory and other storage devices that execute the instructions resident in memory, which are responsive to other instructions generated by the system, or which are provided at an operator interface 34. The processor 252 is configured to execute the stored program instructions as well as to access data stored in one or more data tables.

The processor 252 and memory 270 are configured to monitor the movement of the main frame 16 and the work tool 12. At least one sensor, such as an inertial measurement unit (or “IMU”) 262 is coupled with the dozer blade 23 (seen in FIG. 1). Although the sensor in this embodiment is described as an IMU, it is contemplated that the sensor can include other sensor types capable of measuring angular velocities, and forces. The first sensor 262 detects angular velocity and acceleration of the dozer blade. Various accelerations include at least the acceleration of gravity, and distinguishes the types thereof with high accuracy. In a coordinate system (x, y, z), the sensor 262 detects accelerations in an x-axis direction, a y-axis direction, and a z-axis direction as well as angular velocities around the x, y, and z axis. In the example shown in FIG. 1, the Y-axis is an axis parallel to front-rear directions of the dozer blade, the x-axis is an axis parallel to a width direction of the dozer blade, and the z-axis is an axis orthogonal to both the axis and the y-axis. The coordinate system (x, y, z) may be, for example, a dozer blade coordinate system.

In an alternative configuration, a second sensor 260 coupled with the main frame 16 may be used in conjunction with the first sensor 262. The use of the first sensor 262 with the second sensor 260 can help reduce background noise by measuring the difference in vibration between the main frame 16 the work tool as opposed to mere absolute values to provide precise results. Any drift the work vehicle 10 may encounter with time and overall wear is filtered by using the relative values between the first sensor 262 and the second sensor 260.

The controller 220 is in communication with the first sensor 262 and the second sensor 260, wherein the controller 220 includes a processor 252 and a memory 270 having a work tool shake measurement sequence algorithm 290 stored thereon. The processor 252 is operable to execute the work tool shake measurement sequence algorithm 290 to perform the following to identify whether the pins 110 and bushings 112 coupling the work tool 12 with the main frame 16 are worn and in need replacement.

The program instructions that cause the processor 252 to position the work tool 12 above the ground surface, activate a work tool shake measurement sequence algorithm, monitor the first sensor 262 to determine a movement amount of at least the first sensor 262 (according to the first configuration), and possibly relative to the second sensor 260 (according to the second configuration), to determine if the movement amount of the first sensor 262 exceeds an excessive wear threshold 118. In the present embodiment, the work tool 12 comprises a dozer blade 23.

FIG. 3 is an architecture diagram of the pin and bushing wear detection system 200 for the work vehicle 10 that enables and analyzes shaking of the work tool 12 to gauge pin 110 and bushing 112 wear 106. The pin and bushing wear detection system 200 includes a work tool control lever 210, an electronic controller 220, and electro-hydraulic control valve 230, a work tool actuator 150, and a hydraulic pump 250. The electro-hydraulic control valve 230 in the exemplary embodiment is a 2-way/3-position valve that controls fluid flow from the hydraulic pump 250 to the work tool actuator 150. The controller 220 sends electrical signals to electric solenoids of the electro-hydraulic control valve 230 to control the position of the electro-hydraulic control valve 230. The operator can use the work tool control lever 210 to send control signals to the controller 220 to actuate signals sent to the solenoids (232, 234) of the electro-hydraulic control valve 230.

The work tool actuator 150 includes the headhydraulic cylinder 152 and the piston rod 154 which can be used to move the dozer blade 23. The electro-hydraulic control valve 230 includes a first solenoid 232 and a second solenoid 234 that position the electro-hydraulic control valve 230 in one of its three positions. In the first (left) position, flow from the hydraulic pump 250 is directed by the electro-hydraulic control valve 230 to extend the work tool actuator 150. In the second (center) position, the electro-hydraulic control valve 230 blocks flow from the hydraulic pump 250 to the work tool actuator 150. In the third (right) position, flow from the hydraulic pump 250 is directed by the electro-hydraulic control valve 230 to retract the work tool actuator 150.

The work tool control lever 210 can include a work tool shake switch or button 212 to activate the work tool shake measurement sequence algorithm. 290. In a more broad description the operator initiated mechanism includes an operator interface 34 with a toggle switch, lever, roller, or icon. When the button 212 is pressed, an activate vibration signal is sent from the work tool control lever 210 to the controller 220. The controller 220 then sends electrical signals to the solenoids (232, 234), to cause the electro-hydraulic control valve 230 to “shake” or vibrate” the work tool 12. Alternatively, the actuator oscillates between a first position to a second position within a frequency range.

FIG. 3 further shows sample waveforms (232s and 234s) that can be sent to the solenoids, respectively, of the control valve 230. The complementary square waveforms (232s, 234s) will repeatedly move the control valve 230 between the first and third positions which will repeatedly extend and retract the work tool actuator 150 causing the work tool 12 to shake or vibrate. In one mode of execution, the waveform (232s, 234s) can repeatedly move the control valve 230 to actuate the actuator without work being performed. Alternatively the work tool shake measurement sequence algorithm 290 may be activated with the controller 220 superimposing the waveform (232s, 234s) on top of an existing operator work tool command.

The superimposed waveforms (232s, 234s) have an established amplitude and frequency for the work tool shake measurement sequence algorithm, or alternatively because an identified range yields optimal results in differentiating pins and bushings from those within range of operational function to those that fall outside the range where maintenance is required. Alternatively the amplitude and frequency of the superimposed waveform can be made adjustable by a vehicle monitor through the use of discrete settings (for example, “low” “medium”, or “high”). In yet another embodiment, one or more of the amplitude and frequency settings may be adjusted through a full proportional range with a dial or other control mechanism.

The work tool shake measurement sequence algorithm 290 comprises shaking the work tool 12 by repeatedly expanding and contracting a work tool actuator 150 coupled with the work tool 12. The expanding and contracting of the work tool actuator 150 is performed at less than a maximum hydraulic flow capacity 505 (i.e. maximum flow) to the work tool actuator 150. FIGS. 5A and 5B show a square waveform (232s, 234s) for the work tool shake sequence over time (x-axis) as identified in seconds. The y-axis discloses the relative flow capacity from zero to one (i.e. as a percentage of the maximum flow capacity with zero being and one being 100%) flow capacity in a first tilt command direction and a second tilt command direction. The work tool 12 or dozer blade 23 roll rate 515 is sensed by the first sensor 262, as shown by the squiggly waveform 520 correlating to the square waveform (232s, 234s). Because of pin and bushing wear, the “slop” doesn't result in movement aligned with the tilt commands. Rather, the increased tolerance attributed to wear, dampens the response movement of the work tool 12 and the respective vibration sensed by the first sensor 262. This is contrary to a “good” pin (i.e. a pin within specification) which moves with the appropriate magnitude during a “shake”.

FIGS. 5A and 5B show a square waveform (232s, 234s) for the tool shake measurement sequence 290 over time (x-axis) as identified in seconds. The y-axis discloses the flow capacity from zero to one (i.e. 100%) flow capacity, seen as an amplitude, in a first tilt command direction and a second tilt command direction with the zero marking a neutral position, or no tilt. The work tool 12 or dozer blade 23 roll rate 515 is sensed by the first sensor 262, as shown by the measured squiggly waveform 520 correlating to the square waveform (232s, 234s). FIG. 5A demonstrates the sensed (or measured) roll rate 515 with bushings 112 and pins 110 in need of replacement. FIG. 5B demonstrates the sensed (measured) roll rate with bushings 112 and pins 110 in good condition. The relative movement introduced from wear when the work tool shake measurement sequence algorithm 290 is activated is an indicator of the degree of wear without requirement of a visual inspection. In particular, and as seen in FIGS. 5A and 5B, identifying worn pins 110 and bushings 112 by expanding and contracting of the work tool actuator 150 is performed at or approximately at 50% of a maximum amount of hydraulic flow capacity 505 capable of going to the work tool actuator 150. This tilt command of approximate hydraulic flow at 50% is the “sweet spot” enabling differentiation between worn and good pins. The sensed blade roll rate 515 falls within +/−20 degrees resulting in the corresponding sensed vibration waveform from the first sensor 262. Additionally, the expanding and contracting of the work tool actuator 150 is performed at or above a threshold frequency 525a but below the normal shake sequence frequency wherein the normal shake sequence frequency is the conventional frequency setting for “shaking” stuck ground material on the work tool 12. When performing the work tool shake measurement sequence algorithm 290 at the reduced command with the tilt actuator 42, this wear threshold 118 is monitored in the direction of roll 90. Insufficient flow capacities (i.e. well below 50%) or insufficient frequency (i.e. below the threshold frequency 525a) will also fail to distinguish between a good pin and worn pin.

Contrary to the comparative results shown in FIGS. 5A and 5B, FIGS. 6A (pins and bushing in good condition) and 6B (worn pins and bushings) show the roll rate 515 sensed by the first sensor 262, as the squiggly waveform 520 in response to a square waveform (232s, 234s) commanding the tilt actuator 42. The tilt command ratio, shown in FIGS. 6A and 6B, oscillating between maximum flow capacities 505 (i.e. one and negative one) in opposing directions is a more aggressive “shake” than the tilt command ratio, shown in FIGS. 5A and 5B which oscillates between 50% flow capacities 505 in opposing directions. The comparative difference between FIGS. 6A (worn pins) and 6B (good pins) are nearly indistinguishable, thereby indicating the tilt command operating at approximately 50% flow capacities yielding sufficient sensitivity to identify pin and bushing wear by the sensing of vibrations from “shake” actuations. The pin and bushing wear detection system 200 advantageously allows for absolute values for a pass/not pass status rather than collecting “baseline” data from a multitude of work vehicles. Furthermore, the system 200 and associated method 400 avoids a large dependency on the calibration of the first sensor 262 and/or the second sensor 260, and a hydraulic system calibration. Furthermore, the system 200 enables execution without requiring the operator to physically leave cab 22, or alternatively if operated autonomously, semi-autonomously, or remotely.

The work vehicle 10 further comprises of a display 280, either physically within the cab 22 or at a remote operator station. The work tool shake measurement sequence algorithm 290 further comprises displaying an alert 295 when the movement amount of the first sensor 262 exceeds the wear threshold 118, which indicates excessive wear. The work tool shake measurement sequence algorithm 290 may further comprise of an activation including the gradually increasing of the expansion and contraction of the work tool actuator 150 coupled with the work tool 12 until a threshold velocity 297 is sensed by the first sensor 262.

FIG. 4 discloses a method 400 of evaluating bushings 112 and pins 110 on a work vehicle 10. The method 400 comprises at least the following. In step 410, the work tool 12 is positioned in air above a ground surface. That is the blade does not make contact with the ground surface, and is sufficiently elevated such that the blade will not interfere with the ground surface during the actuation of the tilt actuator 42 during a “shake” command. In step 420, the method work tool shake measurement sequence algorithm 290 is activated. Subsequently, in step 430, at least one sensor (such as an inertial measurement unit 262) coupled with the dozer blade 23 is monitored. Alternatively, for improved precision, a second sensor 260 coupled with the main frame 16 monitored to determine a comparative movement amount of the first sensor 262 relative to the second sensor 260. In step 440, a processor on the controller or the controller 220 determines if the movement amount of the first sensor 262 exceeds an excessive wear threshold 118. The excessive wear threshold 118 may be predetermined or derived from a baseline threshold when the pins and bushings were last replaced.

The controller 220 is in communication with the first sensor 262 and the second sensor 260, where the controller 220 includes a processor 252 and a memory 270 having a work tool shake measurement sequence algorithm 290 stored thereon. The work tool shake measurement sequence activation 290 comprises an increasing pressure of hydraulic fluid sent to the work tool actuator 150 until a work tool shake pressure is reached. In one embodiment, the roll rate sensed by the first sensor 262 is compared to the roll rate 515 sensed by the second sensor 260), wherein the second sensor 260 provides a relative baseline to ascertain the degree of wear. Alternatively, the roll rate 515 from the first sensor 262 may be utilized in gauging the degree of wear by comparing to historical values stored in memory 270, or a predetermined excessive wear threshold 118.

The operator interface 34 can include controls to engage/disengage the pins and bushings wear detection. The pins 110 and bushings 112 wear detection could be engaged by the operator activating a physical switch (e.g., button, or similar, etc.) or a virtual switch (e.g., an icon on a touch screen). The pins 110 and bushings 112 wear detection system 200 could also be passively engaged where it would be available, but would only activate when the desired conditions are detected and the system automatically engages without operator input (e.g., automatic engagement of the bushing wear detection system 200).

Also, a number of operator interface (i.e., user interface (UI)) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands. The operator interface 34 alternatively, or in addition, may be located off the work vehicle 10 (e.g., it could be located at a remote location).

The computer software applications, in other embodiments, may be located in the cloud (e.g., a server or other remote computer arrangement). The executed software includes one or more specific applications, components, programs, objects, modules, or sequences of instructions typically referred to as “program code”. The program code includes one or more instructions located in memory and other storage devices which execute the instructions which are resident in memory, which are responsive to other instructions generated by the system, or which are provided by an operator interface 34 operated by the user (e.g., located in the main frame 16 or at a remote location). The electronic processor 252 is configured to execute the stored program instructions.

Without in any way limiting the scope, interpretation, or application of the claims appearing below, a technical effect of one or more of the example embodiments disclosed herein is by utilizing the combination of a shake sequence with movement in a first direction and measuring the vibration sensed from an sensor in a second direction orthogonal to the first direction, the pin and bushing wear detection to identify pins/bushings (110, 112) worn beyond the suggested limit for optimal grade performance can be initiated intentionally by the operator or automatically during operation without a dedicated routine. Another technical effect of one or more of the example embodiments disclosed herein is being able to derive wear indicators from an absolute threshold as opposed to requiring the collection of data over a period of time or averaging baseline data on several machines. Another technical effect of one or more of the example embodiments disclosed herein is not requiring the high dependency on sensor calibration or hydraulic calibration. That is, false positives for wear will not occur simply because of a drift in calibration because the sensed sensor vibrations are substantially more during a shake sequence than during a mere drift in calibration.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A work vehicle comprising:
a main frame;
a work tool movably coupled with the main frame;
a first sensor coupled with the work tool;
a second sensor coupled with the main frame; and
a controller, in communication with the first sensor and the second sensor, wherein the controller includes a processor and a memory having a work tool shake measurement sequence algorithm stored thereon, wherein the processor is operable to execute the work tool shake measurement sequence algorithm to:
position the work tool above a ground surface;
activate a work tool shake measurement sequence;
monitor the first sensor to determine a movement amount for the second sensor relative to the first sensor; and
determine if the movement amount of the first sensor exceeds an excessive wear threshold.

2. The work vehicle of claim 1, wherein the work tool shake measurement sequence algorithm further comprises shaking the work tool by repeatedly expanding and contracting a work tool actuator coupled with the work tool.

3. The work vehicle of claim 2, wherein the expanding and contracting the work tool actuator is performed at a level below a maximum amount of hydraulic flow capacity capable of going to the work tool actuator.

4. The work vehicle of claim 3, wherein the expanding and contracting the work tool actuator is performed at 50% of a hydraulic flow capacity capable of going to the work tool actuator.

5. The work vehicle of claim 1 further comprises a display where the work tool shake measurement sequence algorithm displays an alert on the display when the movement amount of the first sensor exceeds the excessive wear threshold.

6. The work vehicle of claim 1, wherein activating the work tool shake measurement sequence algorithm comprises increasing expansion and contraction a work tool actuator coupled with the work tool until a threshold velocity of the work tool sensed by the first sensor is reached.

7. The work vehicle of claim 2, wherein the expanding and contracting the work tool actuator is performed above a threshold frequency.

8. A method of evaluating bushings, the method comprising:
positioning a work tool above a ground surface;
activating a work tool shake measurement sequence;
monitoring, by a controller, at least one sensor coupled with the work tool to determine a movement amount of the sensor; and
determining, by the controller, if the movement amount of the sensor exceeds an excessive wear threshold.

9. The method of claim 8, wherein the controller is in communication with the sensor, where the controller includes a processor and a memory having a work tool shake measurement sequence algorithm stored thereon.

10. The method of claim 8, wherein the work tool shake measurement sequence comprises shaking the work tool by repeatedly expanding and contracting a work tool actuator coupled with the work tool.

11. The method of claim 10, wherein the expanding and contracting the work tool actuator is performed at a level below a maximum amount of hydraulic flow capacity capable of going to the work tool actuator.

12. The method of claim 10, wherein the expanding and contracting the work tool actuator is performed at 50% of a hydraulic flow capacity capable of going to the work tool actuator.

13. The method of claim 10, wherein the work tool shake measurement sequence comprises an increasing pressure of hydraulic fluid sent to the work tool actuator until a work tool shake pressure is reached.

14. The method of claim 8, further comprising displaying an alert when the movement amount of the sensor exceeds the excessive wear threshold.

15. The method of claim 10, wherein the activating the work tool shake measurement sequence further comprises increasing expansion and contraction of a work tool actuator coupled with the work tool until a threshold velocity of the work tool sensor is reached.

16. A work vehicle comprising:
a main frame;
a work tool coupled with the main frame;
at least one sensor coupled with the work tool; and
a controller, in communication with the sensor, wherein the controller includes a processor and a memory having a work tool shake measurement sequence algorithm stored thereon, wherein the processor is operable to execute the work tool shake measurement sequence algorithm to:
position the work tool above a ground surface;
activate a work tool shake measurement sequence;
monitor the sensor to determine a roll rate for the sensor;
determine if the movement amount of the sensor exceeds an excessive wear threshold;
displays an alert on a display when the movement amount of exceeds the excessive wear threshold.

17. The work vehicle of claim 16, wherein the work tool shake measurement sequence comprises shaking the work tool by repeatedly expanding and contracting a tilt actuator coupled with the work tool, the shaking performing at a level below a maximum amount of hydraulic flow capacity capable of going to the work tool actuator.

18. The work vehicle of claim 17, wherein the expanding and contracting the work tool actuator is performed at 50% of a hydraulic flow capacity capable of going to the work tool actuator and above a threshold frequency.

19. The work vehicle of claim 16, wherein activating the work tool shake measurement sequence comprises increasing expansion and contraction the tilt actuator coupled with the work tool until a threshold velocity of the work tool sensor is reached.

20. The work vehicle of claim 17, wherein the work tool shake measurement sequence is initiated only after a hydraulic warmup and a confirmation of calibration of the work tool actuator.
